(19) United States
(12) Patent Application Publication
(10) Pub. No.: US 2026/0066821 A1
(43) Pub. Date: Mar. 5, 2026

(54) METHOD, CONTROLLER AND COMPUTER PROGRAM FOR OPERATING AN INVERTER, AND INVERTER SYSTEM

(71) Applicant: ABB Schweiz AG, Baden (CH)

(72) Inventors: Joni Heikkilä, Helsinki (FI); Tuomas Pulli, Helsinki (FI); Ville Pirsto, Helsinki (FI)

(21) Appl. No.: 19/311,509

(22) Filed: Aug. 27, 2025

(30) Foreign Application Priority Data
Sep. 2, 2024 (EP) 24197834.5

(51) Int. Cl. H02P 9/10; H02P 9/02

(52) U.S. Cl. CPC H02P 9/102; H02P 9/02

(57) ABSTRACT

A method for operating an inverter for driving a generator is described. The inverter comprises a DC-link having a DC-link capacitor and the inverter configured to convert a three-phase AC voltage generated by the generator into a DC-link voltage to be applied to the DC-link capacitor. The method comprises receiving a power reference value which is representative of a power to be provided by the generator, and determining an estimated mechanical frequency of the generator. The method further comprises determining a harmonic component of the estimated mechanical frequency, and determining a torque reference value based on the power reference value and the determined harmonic component. The torque reference is representative of a torque to be generated by the generator. The method additionally comprises generating a switching signal for the inverter based on the determined torque reference value, and operating the inverter by supplying the switching signal to the inverter.

### CROSS REFERENCE TO RELATED APPLICATIONS

The present application claims priority to European Patent Application No. 24197834.5 filed on Sep. 2, 2024, and titled “METHOD, CONTROLLER AND COMPUTER PROGRAM FOR OPERATING AN INVERTER, AND INVERTER SYSTEM”, which is hereby incorporated by reference in its entirety.

### TECHNICAL FIELD

The present disclosure relates to the field of electrical inverters. In particular, the present disclosure relates to a method, a controller, and a computer program for operating an inverter configured to drive a generator, and to an inverter system comprising the controller. Further, the present disclosure relates to a computer-readable medium on which the computer program is stored.

### BACKGROUND

Applications where the DC-link voltage is controlled by an inverter driven generator are becoming more common. An inverter configured to drive a generator typically comprises a DC-link having a DC-link capacitor, a DC terminal configured to connect to a DC device or a DC grid, an AC terminal coupled to the generator, and a set of semiconductor switches configured to convert a three-phase AC voltage generated by the generator into a DC-link voltage applied to the DC-link capacitor. One prominent exemplary application in this context is an inverter driven generator configured to supply energy to a DC grid of a ship or to an electric vehicle, such as a train, such as a tram or subway, or to convert electric energy generated by a wind turbine. In some applications, such as shaft generators in ships, for example, the shaft speed may be controlled by a diesel engine. The diesel engine may introduce large torque ripple and consequent a large speed ripple that cannot be suppressed. For example, a 7-cylinder 2-stroke diesel engine may introduce a large seventh harmonic frequency component to the speed. A large harmonic frequency component in the speed then may result in a harmonic frequency component in the DC link voltage. This may reduce the lifetime of batteries and/or capacitors connected to the DC link, and thereby of the inverter.

A conventional approach for calculating a torque reference may be:

$${T}_{REF} = \frac{{P}_{REF}}{{Ω}_{EST}} \qquad ( 1 )$$

where PREF is a power reference value and REST is an estimated mechanical frequency of the generator. The power reference value PREF is typically an output of a PI controller controlling the DC link voltage. This approach works quite well when the mechanical frequency and consequently the torque are constant in steady state. However, when a strong harmonic component exists in the mechanical frequency and consequently in the torque, as explained above in context with the 7-cylinder 2-stroke diesel engine, this approach may result in a harmonic frequency component in the power and consequently in the DC link voltage. There are two main reasons for this. Firstly, the estimated mechanical frequency is typically low pass filtered which causes a phase shift between the estimated mechanical frequency and the actual mechanical frequency. Secondly, maintaining the harmonic frequency component in the torque also requires power due to the motor inductance. Another approach for calculating the torque reference that considers these two effects is therefore needed to avoid the above-mentioned reduction of the lifetime of inverter.

### BRIEF DESCRIPTION

It is an objective of the present disclosure to provide a method, a controller, and a computer program for operating an inverter configured to drive a generator, which contribute to a long lifetime of the inverter. It is another objective of the present disclosure to provide an inverter system comprising the controller and the inverter. It is another objective of the present disclosure to provide a computer-readable medium on which the computer program is stored.

These objectives are achieved by the subject-matter of the independent claims. Further exemplary embodiments are evident from the dependent claims and the following description.

A first aspect relates to a method for operating an inverter configured to drive a generator. The inverter comprises a DC-link having a DC-link capacitor and the inverter configured to convert a three-phase AC voltage generated by the generator into a DC-link voltage to be applied to the DC-link capacitor. The method comprises: receiving a power reference value which is representative of a power to be provided by the generator; determining an estimated mechanical frequency of the generator; determining a harmonic frequency component of the estimated mechanical frequency; determining a torque reference value depending on the power reference value and the determined harmonic frequency component, wherein the torque reference is representative of a torque to be generated by the generator; generating a switching signal for the inverter depending on the determined torque reference value; and operating the inverter by supplying the switching signal to the inverter. The power to be provided by the generator may be an electrical power output by the generator.

A second aspect relates to a main controller for operating the inverter configured to drive the generator. The main controller comprises: a memory configured to store one or more estimated and/or determined values; and a processor communicatively coupled to the memory and being configured to carry out the method as described above and in the following.

A third aspect relates to an inverter system. The inverter system comprises the inverter configured to drive the generator and the main controller configured to operate the inverter.

A fourth aspect relates to a computer program for operating the inverter configured to drive the generator. The computer program comprises computer-readable instructions which, when being executed by the processor of the controller, carry out the method as described above an in the following.

A fifth aspect relates to a computer-readable medium on which the computer program is stored. The computer-readable medium may be a floppy disk, a hard disk, an USB (Universal Serial Bus) storage device, a RAM (Random Access Memory), a ROM (Read Only Memory), an EPROM (Erasable Programmable Read Only Memory) or a FLASH memory. The computer readable medium may also be a data communication network, such as the Internet, which allows downloading a program code. In general, the computer-readable medium may be a non-transitory or transitory medium.

It has to be understood that some features of the present disclosure are described with respect to one of the aspects only for conciseness reasons and to avoid unnecessary repetitions, but that these features may be easily transferred to one or more of the other aspects by the person skilled in the art.

The method may be carried out by the main controller configured to control the inverter. The power reference value may be predetermined and/or may be sent to the main controller by an external device. The external device may be external with respect to the main controller and/or with respect to the inverter. The estimated mechanical frequency may be determined from the three-phase AC voltage and the corresponding three-phase output current of the inverter, such as by a flux observer, or it may be measured, for example, by an encoder. In this case, the “measured” mechanical frequency may correspond to the “estimated” mechanical frequency, because the encoder does not measure the mechanical frequency directly, but counts teeth or magnetic pads on an encoder wheel of the encoder and estimates the mechanical frequency based on the counted number of teeth or, respectively, magnetic pads.

The inverter may comprise two or more, for example six, semiconductor switches configured to convert the AC-voltage into the DC-link voltage. The switching signal may comprise switching commands for the semiconductor switches. When generating the switching signal, timing limitations of the semiconductor switches, such as an interlocking time and/or a minimal on/off time of the semiconductor switches, may be considered. The switching signal, in particular the switching commands, then may be translated into gate voltages configured to control the semiconductor switches, as it is known in the art. The inverter may be a two-level voltage source inverter or a three-level voltage source inverter, for example.

According to an embodiment, the method comprises: determining a harmonic compensation component from the harmonic frequency component of the estimated mechanical frequency, wherein the torque reference value is determined depending on the determined harmonic frequency component of the estimated mechanical frequency by determining the torque reference value from the harmonic compensation component. This may contribute to determine the torque reference value very accurately.

According to an embodiment, the harmonic compensation component is determined from the harmonic frequency component of the estimated mechanical frequency by a transfer function which depends on at least one time constant. This may contribute to a high accuracy of the method described above.

According to an embodiment, the transfer function depends on another time constant, the other time constant is determined depending on the power reference value. In addition, the other time constant may be determined depending on a magnitude of a permanent magnet flux of the generator, and/or on a constant or relatively slowly changing component wo of the mechanical frequency. This may contribute to determine the torque reference value very accurately. The other time constant may be referred to as third time constant.

According to an embodiment, the method comprises: determining a mechanical frequency output from the harmonic compensation component, wherein the torque reference value is determined from the harmonic compensation component by determining the torque reference value from the mechanical frequency output. This may contribute to determine the torque reference value in an easy way.

According to an embodiment, the mechanical frequency output is determined from the harmonic compensation component by adding the harmonic compensation component to the estimated mechanical frequency, wherein the mechanical frequency output corresponds to the sum of the harmonic compensation component and the estimated mechanical frequency. This may contribute to determine the torque reference value in an easy way.

According to an embodiment, the torque reference value is determined from the mechanical frequency output by dividing the power reference value through the mechanical frequency output, wherein the resulting quotient corresponds to the torque reference value. This may contribute to determine the torque reference value in an easy way.

According to an embodiment, the harmonic frequency component of the estimated mechanical frequency is determined from the estimated mechanical frequency by a band-pass filter. This may contribute to determine the torque reference value in an easy way. The band-pass filter may be a second order band-pass filter, for example. A transfer function corresponding to the band-pass filter may be referred to as first transfer function.

These and other aspects of the present disclosure will be apparent from and elucidated with reference to the embodiments described hereinafter.

### BRIEF DESCRIPTION OF DRAWINGS

The subject matter of the present disclosure will be explained in more detail in the following text with reference to exemplary embodiments which are illustrated in the attached drawings.

FIG. 1 shows an example of an inverter configured to drive a generator.

FIG. 2 shows an exemplary embodiment of a main controller configured to operate an inverter.

FIG. 3 shows an exemplary embodiment of a current reference generation block of the main controller of FIG. 2.

The reference symbols used in the drawings, and their meanings, are listed in summary form in the list of reference symbols. In principle, identical parts are provided with the same reference symbols in the figures.

### DETAILED DESCRIPTION

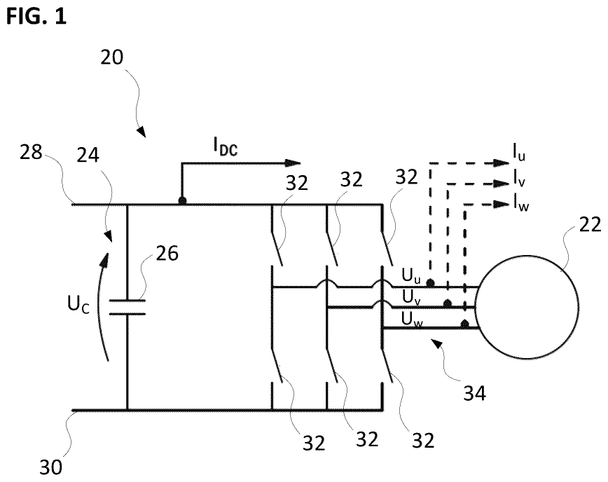

FIG. 1 shows an inverter 20, in particular an electrical inverter. The inverter 20 is electrically coupled to a generator 22. The inverter 20 is configured to drive the generator 22. The generator 22 is configured to generate a three-phase AC voltage. The inverter 20 is configured to convert the three-phase AC voltage into a DC voltage. The inverter 20 may be coupled to an external device (not shown) to apply the DC voltage to the external device. As such, the inverter 20 may act as a power source for the external device. The external device may be an electrical DC device or an electrical grid of a ship (not shown), for example. The DC device may be external with respect to the inverter 20. The DC device may be a rechargeable battery. The inverter 20 and the generator 22 may be arranged in a ship. In this case, the DC grid may be a DC grid of the ship. Alternatively, the inverter 20 and the generator 22 may be arranged in an electric vehicle, such as a train or subway, for example, to supply electric energy to an onboard grid of the corresponding electric vehicle. Alternatively, the generator 22 may be a wind turbine.

The inverter 20 comprises a DC-link 24 having a DC-link capacitor 26, a first DC-terminal 28, a second DC-terminal 30, a set of semiconductor switches 32, for example six semiconductor switches 32, and an AC-terminal 34. The inverter 20 is a two-level voltage source inverter. However, in an alternative embodiment, a three-level voltage source inverter may be used, for example.

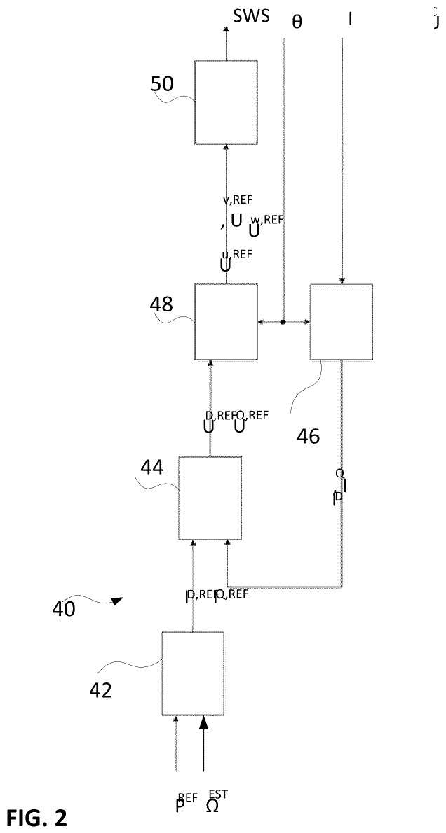

The AC-terminal 34 is coupled to the generator 22. The AC-terminal 34 is configured for receiving the three-phase AC voltage generated by the generator 22. The semiconductor switches 32 are configured to convert the three-phase AC voltage into the DC voltage, in particular a DC-link voltage Uc, applied to the DC-link capacitor 26. To this end, the semiconductor switches 32, in particular gates of the semiconductor switches 32, are coupled to a main controller 40 (see FIG. 2) configured to control the inverter 20.

The three-phase AC voltage consists of a phase u voltage Uᵤ, a phase v voltage Uᵥ, and a phase w voltage U_{w} applied to the AC-terminal 34 by the generator 22. As a result, the generator 22 feeds a three-phase current into the AC-terminal 34. The three-phase current consists of a phase u current Iᵤ, a phase v current Iᵥ, and a phase w current I_{w}.

The three-phase AC voltage is converted by the semiconductor switches 32 into the DC-link voltage U_{C} resulting over the DC-link capacitor 26. This enables to feed a corresponding DC current I_{DC} to the external device.

The DC-terminals 28, 30 are configured to connect to the external DC device or to the DC grid. The first DC-terminal 28 may be coupled to a positive potential of the DC device and the second DC-terminal 30 may be coupled to a negative potential of the DC device.

The inverter 20 may comprise one or more components to measure a current space vector, for example, depending on the phase u current Iᵤ, the phase v current Iᵥ, and the phase w current I_{w} or by using actual states of the switches 32 and the DC-link current IDC. These component(s) may be one or more current sensors (not shown).

FIG. 2 shows an exemplary embodiment of the main controller 40 configured to operate an inverter, for example, the inverter 20 of FIG. 1. The main controller 40 may comprise a current reference generation block 42, a current controller 44, a first transformation block 46, a second transformation block 48, and a modulator 50. In addition, the main controller 40 comprises a memory (not shown) configured to store one or more measured, determined, and/or predetermined current and/or reference values, and a processor (not shown) communicatively coupled to the memory and being configured to carry out a method for operating the inverter 20, as described in the following.

A power reference value PREF to be generated by the inverter 20 may be received by the main controller 40, in particular by the current reference generation block 42. The power reference value PREF may be predetermined and/or may be generated by the external device. The external device may be external with respect to the main controller 40.

In addition, an estimated mechanical frequency Ω_{EST} is determined, for example, by the main controller 40 or by an encoder. In case of the main controller 40 determining the estimated mechanical frequency Ω_{EST}, it may be determined from the three-phase AC voltage and the corresponding three-phase output current of the inverter 20, for example by a flux observer (not shown) as it is known in the art. In case of the encoder determining the estimated mechanical frequency Ω_{EST}, the estimated mechanical frequency Ω_{EST} may be estimated by the encoder and may be determined by the main controller 40 by reading it from the encoder or from the memory.

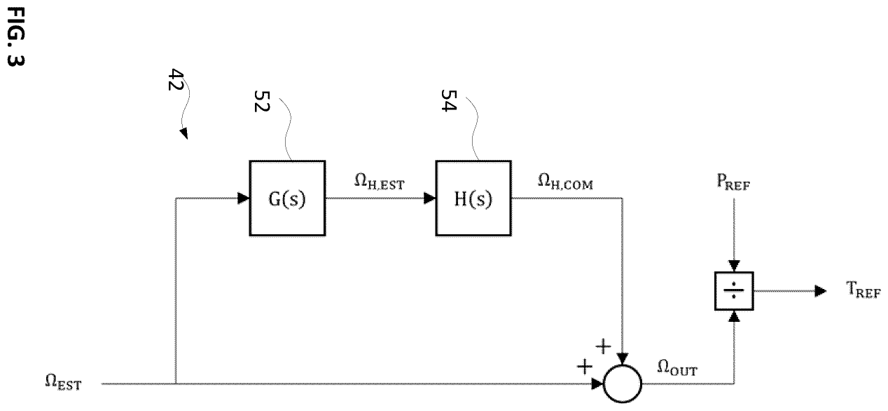

A stator current reference I_{D,REF}, I_{Q,REF} corresponding to a stator current to be generated by the generator 22 may be determined depending on the received power reference PREF and on the estimated mechanical frequency Ω_{EST}, in particular by the current reference generation block 42. When determining the stator current reference I_{D,REF}, I_{Q,REF}, a d-axis stator current reference I_{D,REF} and a q-axis stator current reference I_{Q,REF} may be determined. The determination of the stator current references I_{D,REF}, I_{Q,REF} is explained in more detail with respect to FIG. 3 below.

An actual stator current I generated by the generator 22 may be received by the main controller 40, in particular by the current controller 44. The actual stator current I may be measured by a current sensor (not shown) or may be estimated by the main controller 40. The current sensor may be a component of the generator 22. An actual d-axis stator current component Ip and an actual q-axis current component IQ may be determined from the actual stator current I. The actual d-axis stator current component Ip and the actual q-axis stator current component I_{Q} may be determined from the actual stator current I by a space vector transformation, for example being carried out by the first transformation block 46. In general, a space vector transformation may be used to transform signals from three-phase signals into space vector rotating in synchronous coordinates by utilizing Park and Clarke transformations. Then, a stator voltage reference U_{D,REF}, U_{Q,REF} corresponding to the three-phase AC voltage Uᵤ, Uᵥ, U_{w} to be applied to the generator 22 may be determined depending on the actual d-axis stator current component Ip, the actual q-axis current component I_{Q}, and on the stator current references I_{D,REF}, I_{Q,REF}, for example by the current controller 44.

The stator voltage reference U_{D,REF}, U_{Q,REF} may comprise two stator voltage reference components, for example, a d-axis voltage reference component U_{D,REF} and a q-axis voltage reference component U_{Q,REF}. The d-axis voltage reference component U_{D,REF} and the q-axis voltage reference component U_{Q,REF} in the dq-frame may be transferred into three voltage reference components in the uvw-frame, namely a u-phase voltage reference component U_{u,REF}, a v-phase voltage reference component U_{v,REF} and a w-phase voltage reference component U_{w,REF}, for example, by an inverse space vector transformation which may be carried out by the second transformation block 48. When transferring the stator voltage references U_{D,REF}, U_{Q,REF} in the dq-frame into the three-phase voltage reference components U_{u,REF}, U_{v,REF}, U_{w,REF} in the uvw-frame, an actual angle θ of the rotor may be considered, in particular within the first and/or second transformation block 46, 48. The actual angle θ may be measured by an appropriate sensor, such as a hall-sensor, or may be estimated, for example by the main controller 40.

Then, a switching signal SWS for the inverter 40 may be generated depending on the three voltage reference components U_{u,REF}, U_{v,REF}, U_{w,REF} in the uvw-frame. The switching signal SWS may comprise switching commands for the semiconductor switches 32. When generating the switching signal SWS, timing limitations of the semiconductor switches 32, such as an interlocking time and/or a minimal on/off time of the semiconductor switches 32, may be considered. The switching signal SWS, in particular the switching commands, then may be translated into gate voltages for controlling the semiconductor switches 32, as it is known in the art. So, the modulator 50 translates the voltage reference components U_{u,REF}, U_{v,REF}, U_{w,REF} into gate driver signals in a semiconductor bridge comprising the semiconductor switches 32, which will then realize the corresponding three-phase AC voltage on average over a switching cycle of the inverter 20.

Finally, the inverter 20 may be operated by the main controller 40 by supplying the switching signal SWS to the inverter 20, in particular to the gates of the semiconductor switches 32.

FIG. 3 shows an exemplary embodiment of the current reference generation block 42 of the main controller 40 of FIG. 2. The current reference generation block 42 may have a band-pass filter 52 having a first transfer function G(s), and a block 54 having a second transfer function H(s). The band-pass filter 52 may be a second order band-pass filter, for example.

The current reference generation block 42 may receive the power reference value PREF which is representative of a power to be provided by the generator 22. The power reference value PREF may be predetermined and/or may be sent to the main controller 42 by the external device.

The current reference generation block 42 may receive the estimated mechanical frequency Ω_{EST} of the generator 22. The estimated mechanical frequency Ω_{EST} is representative of a speed of rotation of the generator 22.

A harmonic frequency component Ω_{H.EST} of the estimated mechanical frequency Ω_{EST} may be determined, for example, by the band-pass filter 52. In particular, the harmonic frequency component Ω_{H.EST} may be determined from the estimated mechanical frequency Ω_{EST} by a first transfer function G(s).

A harmonic compensation component Ω_{H.COM} may be determined from the harmonic frequency component Ω_{H.EST} of the estimated mechanical frequency Ω_{EST}. In particular, the harmonic compensation component Ω_{H.COM} may be determined from the harmonic frequency component Ω_{H.EST} by a second transfer function H(s). The transfer function H(s) may depend on the time constants T₁, T₂. The transfer function H(s) may depend on another time constant, wherein the other time constant may be determined depending on the power reference value PREF, as explained below. In addition, the other time constant may be determined depending on a magnitude of a permanent magnet flux Ψ of the generator 22, and/or on a constant or relatively slowly changing component ω₀ of the mechanical frequency. The other time constant may be referred to as third time constant T₃.

Then, a mechanical frequency output Ω_{OUT} may be determined from the harmonic compensation component Ω_{H.COM}. For example, the mechanical frequency output Ω_{OUT} may be determined from the harmonic compensation component Ω_{H.COM} by adding the harmonic compensation component Ω_{H.COM} to the estimated mechanical frequency Ω_{EST}. The mechanical frequency output Ω_{OUT} may correspond to the sum of the harmonic compensation component Ω_{H.COM} and the estimated mechanical frequency Ω_{EST}.

The torque reference value T_{REF} may be determined from the harmonic compensation component Ω_{H.COM} by determining the torque reference value T_{REF} from the mechanical frequency output Ω_{OUT}. For example, the torque reference value T_{REF} may be determined from the mechanical frequency output Ω_{OUT} by dividing the power reference value PREF through the mechanical frequency output Ω_{OUT}, wherein the resulting quotient corresponds to the torque reference value T_{REF}. Then, the current reference generation block 42 may determine the stator current references I_{D,REF}, I_{Q,REF} depending on the torque reference value T_{REF}, for example, by formulas 7 and/or 8 described below, and may output the stator current references I_{D,REF}, I_{Q,REF}, as shown in FIG. 2.

The theoretical background for determining the torque reference value T_{REF}, in particular the above-mentioned transfer functions and thereby for determining the harmonic compensation component Ω_{H.COM} is given in the following:

Assuming that the power P_{INV} received by the inverter 20 is the power of a non-salient permanent magnet machine

$${P}_{INV} = {U}_{D} {I}_{D} + {U}_{Q} {I}_{Q} \qquad ( 2 )$$

where U_{D} and U_{Q} are the stator voltage components and I_{D} and I_{Q} are the actual stator current components in the synchronous reference frame, namely the dq-frame. The stator voltage components are

$${U}_{D} = {RI}_{D} - {Ω}_{ACT} {LI}_{Q} + L \frac{{dI}_{D}}{dt} \qquad ( 3 )$$

$${U}_{Q} = {RI}_{Q} + {Ω}_{ACT} {LI}_{D} + L \frac{{dI}_{Q}}{dt} + {Ω}_{ACT} Ψ \qquad ( 4 )$$

where R and L are the stator resistance and inductance respectively, Ω_{ACT} is the actual mechanical frequency and Ψ is the magnitude of the permanent magnet flux. By substituting equation 3 and equation 4 into equation 2 and by simplifying the resulting equation, an exact relation between the power P_{INV} of the inverter 20 and the stator current components I_{D}, I_{Q} may be found

$${P}_{INV} = {RI}_{D}^{2} + \frac{L}{2} \frac{{dI}_{D}^{2}}{dt} + {RI}_{Q}^{2} + \frac{L}{2} \frac{{dI}_{Q}^{2}}{dt} + {Ω}_{ACT} Ψ {I}_{Q} \qquad ( 5 )$$

Assuming that resistive losses are insignificant, an approximate relation between the power P_{INV} of the inverter 20 and the stator current components I_{D}, I_{Q} may be found

$${P}_{INV} = \frac{L}{2} \frac{{dI}_{D}^{2}}{dt} + \frac{L}{2} \frac{{dI}_{Q}^{2}}{dt} + {Ω}_{ACT} Ψ {I}_{Q} \qquad ( 6 )$$

Assuming that the inverter 20 controls the stator current components I_{D}, I_{Q}, the stator current references I_{D,REF}, I_{Q,REF} for the stator current components I_{D}, I_{Q} are

$${I}_{D , REF} = 0 \qquad ( 7 )$$

$${I}_{QREF} = \frac{{T}_{REF}}{Ψ} \qquad ( 8 )$$

$${T}_{REF} = \frac{{P}_{REF}}{{Ω}_{OUT}} \qquad ( 9 )$$

$${Ω}_{OUT} = {Ω}_{EST} + {Ω}_{H , COM} \qquad ( 10 )$$

where Ω_{OUT} is the mechanical frequency output corresponding to the sum of the estimated mechanical frequency Ω_{EST} and the harmonic compensation component Ω_{H,COM}. Setting the d-axis stator current component I_{D,REF} to zero corresponds to traditional MTPA (Maximum Torque Per Ampere) principle. In practice, the d-axis stator current reference I_{D,REF} may need to be adjusted if a maximum output voltage of the inverter 20 is reached. However, for this analysis the d-axis stator current component I_{D,REF} is assumed to be constant. The power reference P_{REF} is also assumed to be constant in steady state.

For this analysis it may be reasonable to assume that the stator current components I_{D}, I_{Q} follow their corresponding references according to equations 7, 8 and 9

$${I}_{D} = {I}_{D , REF} = 0 \qquad ( 11 )$$

$${I}_{Q} = {I}_{Q , REF} = \frac{{P}_{REF}}{{Ω}_{OUT} Ψ} \qquad ( 12 )$$

$$\frac{L}{2} \frac{{dI}_{D}^{2}}{dt} = 0 \qquad ( 13 )$$

$$\frac{L}{2} \frac{{dI}_{Q}^{2}}{dt} = \frac{L}{2} \frac{{d ( \frac{{P}_{REF}}{{Ω}_{OUT} Ψ} )}^{2}}{dt} = - L \frac{{P}_{REF}^{2}}{{Ω}_{OUT}^{3} {Ψ}^{2}} \frac{d {Ω}_{OUT}}{dt} \qquad ( 14 )$$

By substituting equations 12, 13 and 14 into equation 6 and by modifying, a ratio between the power P_{INV} of the inverter 20 and the power reference P_{REF} is found

$$\frac{{P}_{INV}}{{P}_{REF}} = - L \frac{{P}_{REF}}{{Ω}_{OUT}^{3} {Ψ}^{2}} \frac{d {Ω}_{OUT}}{dt} + \frac{{Ω}_{ACT}}{{Ω}_{OUT}} \qquad ( 15 )$$

Assuming that the mechanical frequency consists of a constant or relatively slowly changing component ω₀ and a time-dependent actual harmonic frequency component Ω_{H,ACT}

$${Ω}_{ACT} = {ω}_{0} + {Ω}_{H , ACT} \qquad ( 16 )$$

Equivalently the estimated mechanical frequency Ω_{EST} consists of the same constant or relatively slowly changing component ω₀ and a time-dependent harmonic component Ω_{H,EST}

$${Ω}_{EST} = {ω}_{0} + {Ω}_{H , EST} \qquad ( 17 )$$

By substituting equations 10, 16 and 17 into equation 15 a ratio between the power P_{INV} of the inverter 20 and the power reference P_{REF} is found

$$\frac{{P}_{INV}}{{P}_{REF}} = - L \frac{{P}_{REF}}{{( {ω}_{0} + {Ω}_{H , EST} + {Ω}_{H , COM} )}^{3} {Ψ}^{2}} ( \frac{d {Ω}_{H , EST}}{dt} + \frac{d {Ω}_{H , COM}}{dt} ) + \frac{{ω}_{0} + {Ω}_{H , ACT}}{{ω}_{0} + {Ω}_{H , EST} + {Ω}_{H , COM}} \qquad ( 18 )$$

Ideally, the ratio between the power P_{INV} of the inverter 20 and the power reference P_{REF} may be one resulting in equation

$${Ω}_{H , EST} + {Ω}_{H , COM} = - L \frac{{P}_{REF}}{{( {ω}_{0} + {Ω}_{H , EST} + {Ω}_{H , COM} )}^{2} {Ψ}^{2}} ( \frac{d {Ω}_{H , EST}}{d t} + \frac{d {Ω}_{H , COM}}{d t} ) + {Ω}_{H , ACT} \qquad ( 19 )$$

To come up with a reasonable equation for the required harmonic compensation component an approximation of equation 19 is considered

$${Ω}_{H , EST} + {Ω}_{H , COM} = - {T}_{3} ( \frac{d {Ω}_{H , EST}}{d t} + \frac{d {Ω}_{H , COM}}{d t} ) + {Ω}_{H , ACT} \qquad ( 20 )$$

where the approximate equivalent third time constant T₃ is

$${T}_{3} = L \frac{{P}_{REF}}{{ω}_{0}^{2} {Ψ}^{2}} \qquad ( 21 )$$

To transform an equation from the time domain to the frequency domain the well-known properties of the Laplace transform may be applied:
1. Laplace transform is linear;
2. Laplace transform of the differential operator d/dt applied to a time domain function

$$f ( t ) is \frac{d}{d t} f ( t ) = sF ( s ) - f ( 0 )$$

where s is a complex variable and F(s) is the frequency domain equivalent of the time domain function f(t).

The initial values of time domain functions of the harmonic frequency component Ω_{H,EST} and the harmonic compensation component Ω_{H,COM} at t=0 may be assumed to be zero. Equation 20 in the frequency domain is then

$${Ω}_{H , EST} + {Ω}_{H , COM} = - {T}_{3} ( s {Ω}_{H , EST} + s {Ω}_{H , COM} ) + {Ω}_{H , ACT} \qquad ( 22 )$$

The harmonic compensation component Ω_{H,COM} can now be solved as

$${Ω}_{H , COM} = \frac{{Ω}_{H , ACT}}{1 + {sT}_{3}} - {Ω}_{H , EST} \qquad ( 23 )$$

Assuming that the estimated mechanical frequency Ω_{EST} approximately equals the actual mechanical frequency Ω_{ACT} but is passed through a filter stage with a well-known transfer function, for example a pair of first order low-pass filters with first and, respectively, second time constants T₁ and T₂

$$\frac{{Ω}_{EST}}{{Ω}_{ACT}} = \frac{1}{1 + s {T}_{1}} \frac{1}{1 + s {T}_{2}} \qquad ( 24 )$$

Furthermore, it is assumed that this same approximation applies also for the harmonic frequency components Ω_{H,EST} and Ω_{H,ACT}

$$\frac{{Ω}_{H , EST}}{{Ω}_{H , ACT}} = \frac{1}{1 + s {T}_{1}} \frac{1}{1 + s {T}_{2}} \qquad ( 25 )$$

Consequently, according to equations 23 and 25, the second transfer function H(s) from the harmonic frequency component Ω_{H,EST} to the harmonic compensation component Ω_{H,COM} is

$$H ( s ) = \frac{{Ω}_{H , COM}}{{Ω}_{H , EST}} = \frac{( 1 + s {T}_{1} ) ( 1 + s {T}_{2} )}{1 + s {T}_{3}} - 1 \qquad ( 26 )$$

The harmonic frequency component Ω_{H,EST} can be extracted from the estimated mechanical frequency Ω_{EST} by a resonator or the band-pass filter 52 with the well-known first transfer function G(s):

$$G ( s ) = \frac{{Ω}_{H , EST}}{{Ω}_{EST}} = \frac{\frac{{ω}_{H}}{Q} s}{{s}^{2} + \frac{{ω}_{H}}{Q} s + {ω}_{H}^{2}} \qquad ( 27 )$$

where ω_{H} is the harmonic frequency to be extracted and Q is the quality factor. By substituting equations 10, 26 and 27 into equation 9 the proposed equation for torque reference value T_{REF} is found

$${T}_{REF} = \frac{{P}_{REF}}{( 1 + G ( s ) H ( s ) ) {Ω}_{EST}} \qquad ( 28 )$$

The fundamental frequency ω₀ may be calculated as an average value of the estimated mechanical frequency Ω_{EST}. The harmonic frequency ω_{H} may be needed for the first transfer function G(s) and may be calculated as

$${ω}_{H} = {K}_{H} {ω}_{0} \qquad ( 29 )$$

where K_{H} is the harmonic number.

An inverter system comprises the inverter 20 configured to drive the generator 22 and the main controller 40 configured to operate the inverter 20.

A computer program configured to operate the inverter 20 configured to drive the generator 22 may be provided. The computer program may comprise computer-readable instructions which, when being executed by the processor of the main controller 40, carry out the method as described above. The computer program may be stored on a computer-readable medium. The computer-readable medium may be a floppy disk, a hard disk, a USB (Universal Serial Bus) storage device, a RAM (Random Access Memory), a ROM (Read Only Memory), an EPROM (Erasable Programmable Read Only Memory) or a FLASH memory. The computer readable medium may also be a data communication network, such as the Internet, which allows downloading a program code. In general, the computer-readable medium may be a non-transitory or transitory medium.

While the present disclosure has been illustrated and described in detail in the drawings and foregoing description, such illustration and description are to be considered illustrative or exemplary and not restrictive; the present disclosure is not limited to the disclosed embodiments. Other variations to the disclosed embodiments can be understood and effected by those skilled in the art and practicing the present disclosure, from a study of the drawings, the disclosure, and the appended claims. In the claims, the word “comprising” does not exclude other elements or steps, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

The disclosed systems and methods are not limited to the specific embodiments described herein. Rather, components of the systems or activities of the methods may be utilized independently and separately from other described components or activities.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A method for operating an inverter that is configured to drive a generator, the inverter comprising a direct-current (DC)-link having a DC-link capacitor, wherein the inverter is configured to convert a three-phase alternating current (AC) voltage generated by the generator into a DC-link voltage to be applied to the DC-link capacitor, the method comprising:
receiving a power reference value which is representative of a power to be provided by the generator;
determining an estimated mechanical frequency of the generator;
determining a harmonic frequency component of the estimated mechanical frequency;
determining a torque reference value based on the power reference value and the determined harmonic frequency component, wherein the torque reference is representative of a torque to be generated by the generator;
generating a switching signal for the inverter based on the determined torque reference value; and
operating the inverter by supplying the switching signal to the inverter.

2. The method according to claim 1, further comprising:
determining a harmonic compensation component from the harmonic frequency component of the estimated mechanical frequency, wherein the torque reference value is determined based on the determined harmonic frequency component of the estimated mechanical frequency by determining the torque reference value from the harmonic compensation component.

3. The method according to claim 2, wherein:
the harmonic compensation component is determined from the harmonic frequency component of the estimated mechanical frequency by a transfer function, which is based on at least one time constant.

4. The method according to claim 3, wherein:
the transfer function is based on another time constant, and
the other time constant is determined based on the power reference value.

5. The method according to claim 2, further comprising:
determining a mechanical frequency output from the harmonic compensation component, wherein the torque reference value is determined from the harmonic compensation component by determining the torque reference value from the mechanical frequency output.

6. The method according to claim 5, wherein:
the mechanical frequency output is determined from the harmonic compensation component by adding the harmonic compensation component to the estimated mechanical frequency, wherein the mechanical frequency output corresponds to the sum of the harmonic compensation component and the estimated mechanical frequency.

7. The method according to claim 6, wherein:
the torque reference value is determined from the mechanical frequency output by dividing the power reference value through the mechanical frequency output, wherein the resulting quotient corresponds to the torque reference value.

8. The method according to claim 1, wherein:
the harmonic frequency component of the estimated mechanical frequency is determined from the estimated mechanical frequency by a band-pass filter.

9. A main controller for operating an inverter that is configured to drive a generator, the inverter comprising a direct current (DC)-link having a DC-link capacitor, wherein the inverter is configured to convert a three-phase alternating current voltage generated by the generator into a DC-link voltage to be applied to the DC-link capacitor, the main controller comprising:
a memory configured to store one or more estimated and/or determined values; and
a processor communicatively coupled to the memory and configured to:
receive a power reference value which is representative of a power to be provided by the generator;
determine an estimated mechanical frequency of the generator;
determine a harmonic frequency component of the estimated mechanical frequency;
determine a torque reference value based on the power reference value and the determined harmonic frequency component, wherein the torque reference is representative of a torque to be generated by the generator;
generate a switching signal for the inverter based on the determined torque reference value; and
operate the inverter by supplying the switching signal to the inverter.

10. An inverter system, comprising:
an inverter configured to drive a generator, the inverter having a direct current (DC-link) having a DC-link capacitor, wherein the inverter is configured to convert a three-phase alternating current voltage generated by the generator into a DC-link voltage to be applied to the DC-link capacitor; and
a main controller configured to operate the inverter, the main controller comprising:
a memory configured to store one or more estimated and/or determined values; and
a processor communicatively coupled to the memory and configured to:
receive a power reference value which is representative of a power to be provided by the generator;
determine an estimated mechanical frequency of the generator;
determine a harmonic frequency component of the estimated mechanical frequency;
determine a torque reference value based on the power reference value and the determined harmonic frequency component, wherein the torque reference is representative of a torque to be generated by the generator;
generate a switching signal for the inverter based on the determined torque reference value; and
operate the inverter by supplying the switching signal to the inverter.

11. (canceled)

12. A non-transitory computer-readable storage medium comprising a computer program configured to operate an inverter, the inverter comprising a direct current (DC)-link having a DC-link capacitor, wherein the inverter is configured to convert a three-phase alternating current voltage generated by the generator into a DC-link voltage to be applied to the DC-link capacitor; and drive a generator, wherein the non-transitory computer-readable storage medium comprises computer-readable instructions which, when executed by a processor of a main controller, the main controller comprising a memory configured to store one or more estimated and/or determined values and a processor communicatively coupled to the memory, causes the processor to:
receive a power reference value which is representative of a power to be provided by the generator;
determine an estimated mechanical frequency of the generator;
determine a harmonic frequency component of the estimated mechanical frequency;
determine a torque reference value based on the power reference value and the determined harmonic frequency component, wherein the torque reference is representative of a torque to be generated by the generator;
generate a switching signal for the inverter based on the determined torque reference value; and
operate the inverter by supplying the switching signal to the inverter.

13. The method according to claim 3, further comprising:
determining a mechanical frequency output from the harmonic compensation component, wherein the torque reference value is determined from the harmonic compensation component by determining the torque reference value from the mechanical frequency output.

14. The method according to claim 4, further comprising:
determining a mechanical frequency output from the harmonic compensation component, wherein the torque reference value is determined from the harmonic compensation component by determining the torque reference value from the mechanical frequency output.

15. The method according to claim 2, wherein the harmonic frequency component of the estimated mechanical frequency is determined from the estimated mechanical frequency by a band-pass filter.

16. The method according to claim 3, wherein the harmonic frequency component of the estimated mechanical frequency is determined from the estimated mechanical frequency by a band-pass filter.

17. The method according to claim 4, wherein the harmonic frequency component of the estimated mechanical frequency is determined from the estimated mechanical frequency by a band-pass filter.

18. The method according to claim 5, wherein the harmonic frequency component of the estimated mechanical frequency is determined from the estimated mechanical frequency by a band-pass filter.

19. The method according to claim 6, wherein the harmonic frequency component of the estimated mechanical frequency is determined from the estimated mechanical frequency by a band-pass filter.

20. The method according to claim 7, wherein the harmonic frequency component of the estimated mechanical frequency is determined from the estimated mechanical frequency by a band-pass filter.

21. The main controller according to claim 9, wherein the harmonic frequency component of the estimated mechanical frequency is determined from the estimated mechanical frequency by a band-pass filter.
